(19) United States
(12) Patent Application Publication
(10) Pub. No.: US 2002/0179381 A1
(43) Pub. Date: Dec. 5, 2002

(54) Actuating cylinder assembly for a vehicle drum brake assembly

(76) Inventor: Larry E. Wilkin, Simi Valley, CA (US)

Correspondence Address: Jack C. Munro, Suite 225, 28720 Roadside Drive, Agoura Hills, CA, 91301, US

(21) Appl. No.: 09/871,362

(22) Filed: Jun. 1, 2001

(51) Int. Cl. F16D 51/00

(52) U.S. Cl. 188/74

(57) ABSTRACT

An actuating cylinder assembly for a vehicle drum brake assembly which comprises a cylinder which has an internal chamber within which is located a piston with this piston to be moved by entry of pressurized fluid within the internal chamber. An actuating shaft has an inner end which is mounted within the internal chamber and connects with the piston and an outer end which extends exteriorly of the cylinder. The outer end is adapted to engage with the drum brake unit of a drum brake assembly. A first seal assembly is located between the cap and the cylinder and the second seal assembly is located between the actuating shaft and the cap.

### BACKGROUND OF THE INVENTION

1 Field of the Invention

The subject matter of the present invention is related to an actuating cylinder assembly for a vehicular drum brake assembly where the actuating cylinder assembly is not capable of being contaminated by water or dirt which may prevent operation of the actuating cylinder assembly.

2 Description of the Related Art

It is a requirement to slow and stop a vehicle. In order to slow and stop a vehicle, a brake is used. Typical vehicles would be automobiles, trucks and trailers. Brakes that are utilized in conjunction with vehicles take a variety of form. Each form of a brake is of a frictional type in which a fixed surface is brought into contact with a moving part which is to be slowed or stopped. The fixed surface and the moving surface are rubbed together and the energy stored in the moving part is converted into heat and dissipated into the atmosphere. The loss of energy from the moving surface is accompanied by a desired reduction of movement. Vehicular brakes generally take two forms, that being a drum brake assembly or disc brake assembly.

In the internal expanding type of drum brake assembly, two brake shoes on a fixed mounting are pushed against the inside of a rotating drum to create the braking force. Generally, the shoes are moved hydraulically. On a drum type of brake, one brake shoe is self energizing and the other shoe is not. If the drum rotation is clockwise, it tends to pull the shoe on the right harder against the inner surface so that the braking affect is increased. This shoe is called the leading shoe. The other shoe, which is the trailing shoe, is pushed off by the transfer from the rear axle to the front axle during normal braking.

In order to affect movement of the braking units, there is utilized an actuating cylinder assembly which is designed to receive hydraulic fluid, either air or oil, and cause extension of an actuator which applies pressure against the leading drum brake unit of the drum brake assembly. In the past, these actuating cylinders have been constructed so that water can easily penetrate the actuating cylinder assembly and also possibly dirt and dust can penetrate the actuating cylinder assembly. This inclusion of water and dirt can cause the actuating cylinder assembly to quickly become inoperative. It would be desirable to somehow design the actuating cylinder assembly so as to free from corrosion due to contamination with water and also free from contamination by dust and dirt.

### SUMMARY OF THE INVENTION

The basic embodiment of the present invention comprises an actuating cylinder assembly for a vehicular drum brake assembly which comprises a cylinder having an internal chamber. Formed within the cylinder is an entry opening which provides access to an internal chamber also formed within the cylinder. A piston is movably mounted within the internal chamber with this piston to be moved by the pressurized fluid. The inner end of an actuating shaft is located within the internal chamber and is to be in connection with the piston. The outer end of the actuating shaft extends exteriorly of the cylinder and is designed to engage with a drum brake unit of the drum brake assembly. A cap is mounted about the entry opening and is secured to the cylinder. The actuating shaft passes through a hole in the cap.

A further embodiment of this invention is where the basic embodiment is modified to where there is a threaded connection between the cap and the cylinder.

A still further embodiment of this invention is where the basic embodiment is modified by there being an inclusion of a first seal between the cap and the cylinder.

In yet a still further embodiment of this invention, the basic embodiment is modified to where the first seal comprises an O-ring.

In yet a still further embodiment of this invention, the basic embodiment is modified to where the O-ring is mounted within an annular groove formed within the cylinder.

In a still further embodiment of this invention, the basic embodiment is modified where there is included a second seal between the actuating shaft and the cap.

In yet a still further embodiment of this invention, the basic embodiment is modified to where the second seal comprises an O-ring.

In yet a further embodiment of this invention, the basic embodiment is modified so that the O-ring is mounted within a second annular groove formed within the cap.

### BRIEF DESCRIPTION OF THE DRAWINGS

For a better understanding of the present invention, reference is to be made to the accompanying drawings. It is to be understood that the present invention is not limited to the precise arrangement shown in the drawings.

FIG. 1 is a front elevational of a brake drum assembly within which has been mounted the actuating cylinder assembly of the present invention;

FIG. 2 is an exterior view of the actuating cylinder assembly of the present invention;

FIG. 3 is a longitudinal cross-sectional view through the front end of the actuating cylinder assembly of the present invention taken along line 3-3 of FIG. 2.

### DETAILED DESCRIPTION OF THE INVENTION

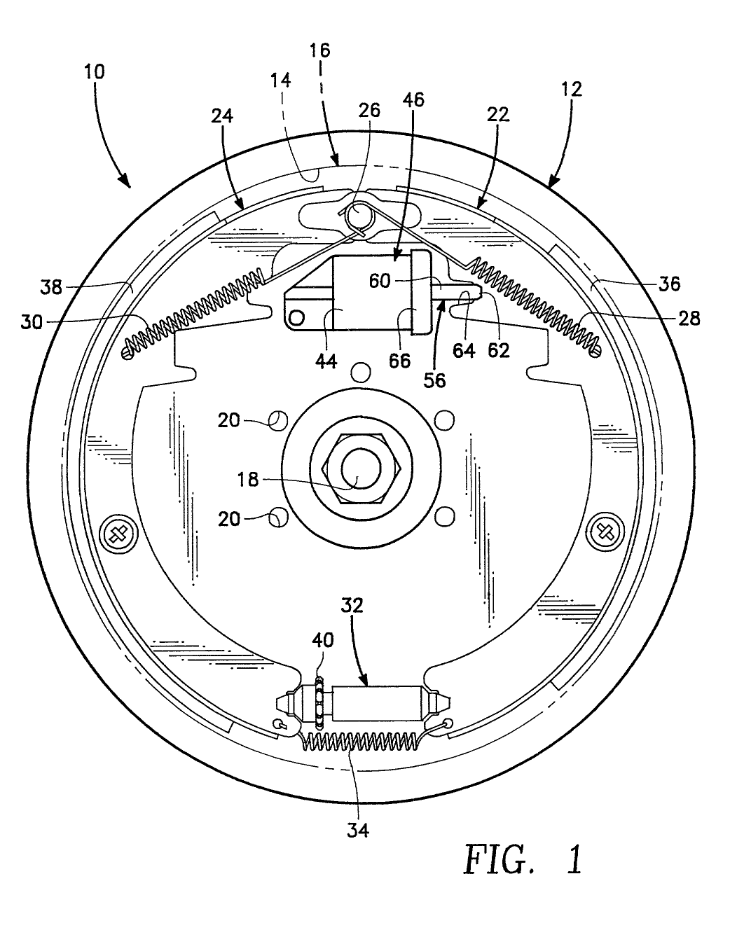

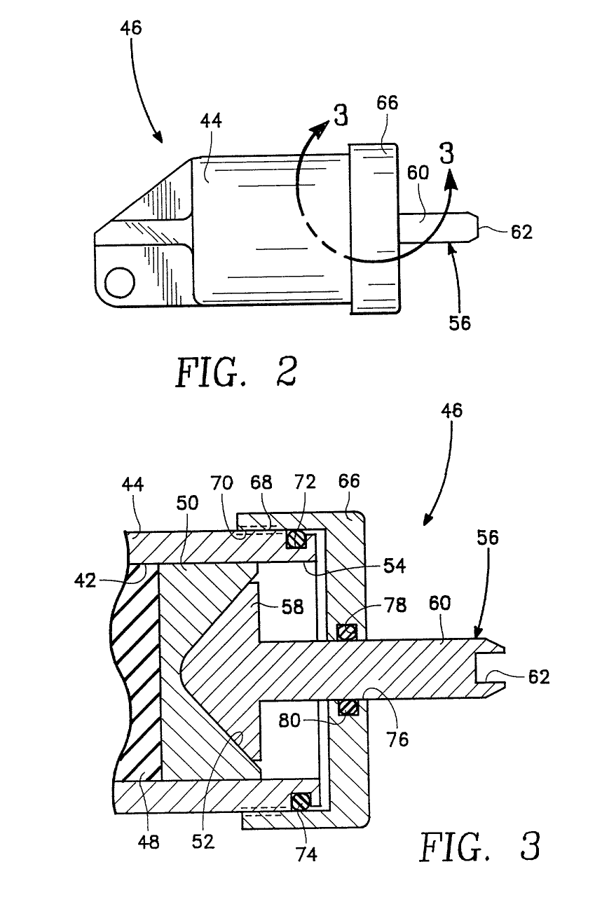

Referring particularly to the drawings, there is shown in FIG. 1 a drum brake pad assembly 10 which includes a fixed baseplate 12, and a drum 16, which is only shown partially. The drum 16 has an annular braking surface 14. The braking surface 14 is in the shape of a circle. The drum 16 is permitted to rotate about an axle 18. A wheel (not shown) is to be mounted by bolts (not shown) to the drum 16. The baseplate 12 is fixedly mounted to the vehicle by bolts (not shown) which are engaged with the wheel mounting holes 20. There are five in number of the holes 20 shown.

The baseplate 12 has mounted thereon a first brake pad unit 22, which is defined as the leading brake pad unit. The baseplate 12 also has a second brake pad unit 24 mounted thereon which is defined as the trailing brake pad unit. The brake pad units 22 and 24 are each independently mounted on a pin 26. The pin 26 is fixedly mounted on the baseplate 12. A spring 28 connects between the first brake pad unit 22 and the pin 26 with a similar spring 30 connecting between the brake pad unit 24 and the pin 26. The function of each of the springs 28 and 30 is to exert a continuous bias against the brake pad units 22 and 24 tending to move such closer together or tending to move the brake pad unit 22 counterclockwise and the brake pad unit 24 clockwise.

Mounted between the brake pad units 22 and 24 is an adjuster mechanism 32. The adjuster mechanism 32 forms no specific part of this invention, but it is the purpose of the adjuster mechanism 32 to be manually movable so as to maintain the brake pad units 22 and 24 in the just clearance position which will permit free rotation of the drum 16 relative to the baseplate 12. This means that the wheel, which is mounted to the drum 16, will freely rotate. Located directly adjacent the adjuster mechanism 32 is a coil spring 34 which is located between the brake pad units 22 and 24. It is the function of the coil spring 34 to exert a continuous bias which causes the brake pad unit 22 to move clockwise and the brake pad unit 24 to move counterclockwise a small distance until the brake linings 36 and 38 of their respective brake units 22 and 24 no longer contact the braking surface 14. This clearance position of the brake linings 36 and 38 is desired to be initially established by the adjuster mechanism 32. It is to be understood that as the brake linings 36 and 38 wear and become less in thickness, that it is desirable to readjust the brake pad units 22 and 24 to establish a new clearance position. This readjusting is accomplished by placing a tool, such as a screwdriver (not shown), in contact with the star wheel 40 of the adjuster mechanism 32 and cause rotation of the star wheel 40. This rotation will cause the adjuster mechanism to lengthen which will result in the brake linings 36 and 38 being moved closer to the braking surface 14 which will compensate for the wear that has occurred on the brake linings 36 and 38.

When the operator of the vehicle applies braking pressure to a pedal within a vehicle (which is not shown), fluid pressure is to be applied to within internal chamber 42 of a cylinder 44 of an actuating cylinder assembly 46. Movably mounted within the internal chamber 42 is a piston 50 which abuts against a cup seal 48. The piston 50 has a central recess 52. Access to within the internal chamber 42 is accomplished by the entry opening 54. Cup seal 48 is constructed of rubber. Piston 50 is constructed of aluminum or plastic.

The actuating cylinder assembly 46 is mounted directly to the baseplate 12. The actuating shaft 56 has an inner end 58 which is defined in a rounded cone shape which is to matingly fit within the central recess 52. The actuating shaft 56 has an outer end 60 which terminates in a bifurcated tip 62. The bifurcated tip 62 is to connect with groove 64 formed within the brake pad unit 22. The bifurcated tip 62 achieves an interlocked connection with the brake pad unit 22 which will prevent accidental disengagement of the actuating shaft 56 from the brake pad unit 22.

A cap 66 has a series of internal screw threads 68. The internal screw threads 68 is to threadingly engage with a series of external screw threads 70 formed on the exterior surface of the cylinder 44. Formed directly adjacent the external screw threads 70 is an annular groove 72. Mounted within the annular groove 72 is an O-ring 74. The O-ring 74 forms a first seal providing a watertight and dust and dirt tight seal between the cap 66 and the cylinder 44 which will prevent entry of water and dust and dirt to within the internal chamber 42.

Formed within the cap 66 is a center hole 76. The actuating shaft 56 passes through the center hole 76 in a close fitting manner but yet the actuating shaft 56 is permitted to move relative to the cap 66. Formed within the wall of the hole 76 is an annular groove 78. An O-ring 80 is mounted within the annular groove 78. The O-ring 80 constitutes a second seal which prevents entry of water and dust and dirt to within internal chamber 42 by being conducted through the hole 76.

It can thus be seen that when fluid pressure is applied to the actuating cylinder 46, that the actuating shaft 56 can move longitudinally relative to the cap 66 with no dust, dirt or water being capable of entering to within the internal chamber 42 which could cause the actuating cylinder 46 to become inoperable. To further assist in preventing corrosion, the entire actuating cylinder assembly 46 may be constructed of stainless steel.

The present invention may be embodied in other specific forms without departing from the essential attributes thereof. Reference should be made to the appending claims rather than the foregoing specification as indicating the scope of the invention.

What is claimed is:

1. An actuating cylinder assembly for a vehicular drum brake assembly comprising:
a cylinder having an internal chamber, an entry opening connecting with said internal chamber and providing access into said internal chamber, said internal chamber adapted to receive pressurized fluid;
a piston movably mounted within said internal chamber, said piston to be moved by the pressurized fluid;
an actuating shaft having an inner end and an outer end, said inner end be located within said internal chamber and connecting with said piston, said outer end extending exteriorly of said cylinder and adapted to engage with a drum brake unit of said drum brake assembly; and
a cap mounted about said entry opening closing such, said cap being secured to said cylinder by securement means, said cap having a center hole, said actuating shaft passing through said center hole with said actuating shaft establishing a close fit with said center hole, said actuating shaft being movable relative to said cap.

2. The actuating cylinder assembly as defined in claim 1 wherein:
said securement means comprising a threaded connection.

3. The actuating cylinder assembly as defined in claim 1 wherein:
first sealing means located between said cylinder and said cap, said first sealing means preventing entry of water and dirt within said internal chamber.

4. The actuating cylinder assembly as defined in claim 3 wherein:
said first sealing means comprising an O-ring.

5. The actuating cylinder assembly as defined in claim 4 wherein:
said O-ring being mounted within a first annular groove formed within said cylinder.

6. The actuating cylinder assembly as defined in claim 1 wherein:
second sealing means located between said actuating shaft and said cap, said second sealing means preventing entry of water and dirt within said internal chamber.

7. The actuating cylinder assembly as defined in claim 6 wherein:
said second sealing means comprising an O-ring.

8. The actuating cylinder assembly as defined in 7 wherein:
said O-ring being mounted within a second annular groove formed within said cap.
